(19) United States
(12) Patent Application Publication
(10) Pub. No.: US 2018/0317475 A1
(43) Pub. Date: Nov. 8, 2018

(54) A TRAP

(71) Applicant: John Michael REDMAYNE, Palmerston North (NZ)

(72) Inventor: John Michael REDMAYNE, Palmerston North (NZ)

(21) Appl. No.: 15/773,188

(22) PCT Filed: Nov. 7, 2016
(86) PCT No.: PCT/NZ2016/050177

§ 371 Date: May 3, 2018

(30) Foreign Application Priority Data
Nov. 5, 2015 (NZ) 713957

(51) Int. Cl. A01M 23/24; A01M 31/00

(52) U.S. Cl. CPC A01M 23/24; A01M 27/00; A01M 31/008; A01M 31/002

(57) ABSTRACT

The invention relates to a trap, which may be a self-setting trap comprising a lockout system configured to prevent the actuation system of the trap from activating a strike member when an energy level of the power supply is below a predetermined threshold. In this way, the trap may be configured to kill an animal quickly, strongly and therefore as humanely as possible. In one embodiment, the trap may comprise a shock absorbing system to protect sensitive components of the trap when the strike member is activated.

### FIELD OF THE INVENTION

The present invention relates to a trap for trapping target creatures.

### BACKGROUND TO THE INVENTION

Management of ecosystems, farming systems, pest control and so forth can require a number of tasks to be performed to control target creatures, such as pests. These tasks may include traps to kill the target creatures.

However, many traps typically require a regular program of maintenance by a worker. For example, in the case of a kill trap, the trap needs to be checked regularly to remove any dead creatures, to reset the trap and replace the lure.

It is an object of the invention to provide a trap that goes at least some way towards overcoming the disadvantages of the prior art, or that at least provides the public with a useful alternative.

### SUMMARY OF THE INVENTION

In one form, the invention comprises a trap comprising: at least one trigger; a strike member; a power supply; an actuating system connected to the strike member and configured to cause the strike member to move from a set position to a strike position when the actuating system is activated, wherein the actuating system is powered by the power supply; and a lockout system configured to prevent the actuation system from activating the strike member when an energy level of the power supply is below a predetermined threshold.

Preferably, the power supply is a compressed gas power supply, and the lockout system comprises a lockout member configured to be moveable between: (a) an open position, in which a compressed gas can flow through the actuating system to enable the actuating system to activate the strike member, and (b) a closed position, in which the lockout member restricts the flow of the compressed gas through the actuating system to prevent the actuation system from activating the strike member when a pressure of the compressed gas at a location in the trap is below a particular threshold.

Optionally, the power supply is a compressed gas power supply wherein: the actuating system comprises a pilot controlled diaphragm valve, and the lockout system comprises a biasing member configured to bias a diaphragm of the pilot controlled diaphragm valve to a closed position when a pressure of a compressed gas at a location in the pilot controlled diaphragm valve is below a particular threshold.

Optionally, the power supply is a compressed gas power supply wherein the actuating system is controlled by an electronic controller, the lockout system comprises a pressure switch configured to measure a pressure of gas in a gas storage location in the trap, and the electronic controller is configured to prevent the actuation system from activating the strike member when a signal status of the pressure switch signals that the pressure of gas at the gas storage location in the trap is below a predetermined threshold.

In another form, the invention comprises a trap comprising: at least one trigger; a strike member; a power supply; an actuating system connected to the strike member and configured to cause the strike member to move from a set position to a strike position when the actuating system is activated; a resetting system connected to the strike member and configured to cause the strike member to move from a strike position to a set position when the resetting system is activated, wherein the resetting system is powered by the power supply; and a lockout system configured to prevent the actuating system from being activated when the strike member has not been moved to the set position due to an insufficient energy level in the power supply.

In yet another form, the invention comprises a trap comprising: at least one trigger; a strike member; a power supply; an actuating system configured to connect to the strike member and configured to cause the strike member to move from a set position to a strike position when the actuating system is activated by the trigger; a resetting system connected to the strike member via a connecting line, wherein the connecting line is also connected to a retractor, wherein the retractor is driven in a first direction by a motor, which causes the retractor to pull on the connecting line to cause the strike member to move from the strike position to the set position; and a shock absorbing transmission system, configured to introduce slack to the connecting line to prevent transmission of an impact force, resulting from activation of the strike member, to the motor.

Preferably, the trap comprises an electronic control system for receiving one or more actuating signals from the at least one trigger and activating the actuating system after receiving one or more of those signals. In one form, the one or more actuating signals are electric signals received from an electrically powered trigger. Optionally, the electrically powered trigger comprises a sensor.

Alternatively, the one or more actuating signals comprise a physical force or movement of a mechanically operated trigger. For example, the mechanically operated trigger may be a switch latch or other component of the trap that moves or contacts a part of the trap to activate the actuating system.

Preferably, a gearing system is attached to the motor. Optionally, the gearing system comprises a gear box.

In one form, the retractor comprises a rotating member. Optionally, the rotating member is a pulley.

Preferably, the electronic control system operates the motor to cause the retractor to be driven in a second direction, which is the reverse of the first direction, to at least partially release the connecting line to introduce slack to the connecting line. Optionally, the connecting line is a flexible and at least partially stretchable line.

Also disclosed herein is a solar powered resetting trap comprising: a lure system, a striking element, a strike surface, one or more batteries, one or more solar charging panels configured to replenish a charge of the one or more batteries, an electric motor, a gear box, a clutch or a shock absorbing transmission system configured to protect the electric motor and/or the gear box from damage upon the striking element being activated, a mechanism for holding the striking element in an open position, a striking element resetting mechanism, one or more springs configured to urge the striking element from a vicinity of the open position toward the strike surface upon the striking element being activated, and a sensor system or trigger mechanism configured to be actuated by a target creature and which is operative to cause the striking element to be activated, wherein: the sensor system or trigger mechanism, the striking element and the strike surface are configured such that upon being activated the striking element is released or urged from its open position and is intended to strike the target creature and compress it against the strike surface and to kill the creature, and the trap is configured to reset the striking element to its open position after it has been activated using a motive power of the electric motor transmitted through the gear box and the clutch or shock absorbing transmission system so as to drive the striking element resetting mechanism.

Preferably the mechanism for holding the striking element in an open position incorporates one or more of: a mechanical latch or trigger, a solenoid latch or trigger, and/or at least one of the one or more springs configured to urge the striking element from the open position toward the strike surface upon the striking element being activated that is also configured to instead hold the striking element in an open position if the striking element has been rotated to an over-centred position.

Preferably the striking element is connected to or is part of a piston rod of a piston powered by one or more springs.

Alternatively the striking element is mounted to rotate about an axis and a rotation of the striking element is powered by one or more springs.

Also disclosed herein is a shock absorbing transmission system comprising: a controller or a system of switches configured to act as a controller, an electric motor, a gear box, an electrical power supply, a pulley, a load, a latch or holding mechanism to latch or hold the load in a raised or tensioned position, and a flexible connector connected to the pulley and to the load, wherein: the controller or system of switches is operative to cause the motor to turn in a direction and transmit a motive power through the gear box to the pulley and cause the pulley to wind in the flexible connector so as to raise or tension the load, the latch or holding mechanism is operative to latch or hold the load in the raised or tensioned position once the load reaches that position, and the controller or system of switches is operative to then cause the motor to turn in the opposite direction and transmit a motive power through the gear box to the pulley and cause the pulley to unwind the flexible connector so as to introduce a slack in the flexible connector between the pulley and the load such that when the latch or holding mechanism holding the load in the raised or tensioned position is unlatched or released the load is allowed to fall or be de-tensioned without transmitting a shock to the gear box and/or the motor of a magnitude that would damage the gear box and/or the motor.

Alternatively the embodiment above is modified so that the flexible connector is also stretchable and winding in the flexible connector also causes the flexible connector to stretch and unwinding the flexible connector also causes the flexible connector to un-stretch, so as to introduce a stretchable slack in the flexible connector between the pulley and the load.

Also disclosed herein is a shock absorbing transmission method applied to a shock absorbing transmission system comprising: a controller or a system of switches configured to act as a controller, an electric motor, a gear box, an electrical power supply, a pulley, a load, a latch or holding mechanism operative to latch or hold the load in a raised or tensioned position, and a flexible connector connected to the pulley and to the load, wherein the method comprises the steps of: operating the motor to turn in a direction and transmit a motive power through the gear box to the pulley and cause the pulley to wind in the flexible connector so as to raise or tension the load, latching or holding the load in the raised or tensioned position once the load reaches that position, and operating the motor to turn in the opposite direction and transmit a motive power through the gear box to the pulley and cause the pulley to unwind the flexible connector so as to introduce a slack in the flexible connector between the pulley and the load such that when the latch or holding mechanism holding the load in the raised or tensioned position is unlatched or released the load is allowed to fall or be de-tensioned without transmitting a shock to the gear box and/or the motor of a magnitude that would damage the gear box and/or the motor.

Alternatively the embodiment above is modified so that the method is applied to a shock absorbing transmission system wherein the flexible connector is also stretchable and further wherein winding in the flexible connector also causes the flexible connector to stretch and unwinding the flexible connector also causes the flexible connector to un-stretch.

Also disclosed herein is a humane kill lockout system for use with a trap or dispensing apparatus wherein: the trap or dispensing apparatus is operative to humanely kill a target creature with an actuated kill mechanism, the trap or dispensing apparatus is powered, at least in part, by compressed gas and/or electricity stored in the apparatus, and a sufficient quantity of compressed gas and/or a sufficient charge of electricity is required in order for the kill mechanism to effect, or to be reset to effect, a humane kill of the target creature, and further wherein the humane kill lockout system is operative to prevent: actuation of the kill mechanism if there is not the sufficient quantity of compressed gas and/or not the sufficient charge of electricity stored in the apparatus to effect a humane kill of the target creature, actuation of the kill mechanism if the kill mechanism has not been reset to an armed position sufficient to effect a humane kill of the target creature, and/or a reset of the kill mechanism if there is not the sufficient compressed gas and/or not the sufficient electricity stored in the apparatus to reset the kill mechanism to an armed position sufficient to effect a humane kill of the target creature.

Preferably the system includes an electronic controller comprising at least one processor and at least one computer-readable memory communicatively coupled to the at least one processor, the electronic controller is configured to estimate a remaining amount of compressed gas stored in the apparatus based on values stored in the at least one computer-readable memory for an initial amount of compressed gas stored in the apparatus and an amount of compressed gas used by the apparatus up until a time of the estimate, and the electronic controller is configured to prevent actuation or reset of the kill mechanism if the estimated remaining amount of compressed gas stored in the apparatus is less than a predetermined threshold amount.

Alternatively the system includes an electronic controller comprising at least one processor and at least one computer-readable memory communicatively coupled to the at least one processor, the electronic controller is configured to estimate a remaining amount of electrical energy stored in the apparatus based on values stored in the at least one computer-readable memory for an initial amount of electrical energy stored in the apparatus and a net amount of electrical energy used by the apparatus up until a time of the estimate, and the electronic controller is configured to prevent actuation or reset of the kill mechanism if the estimated remaining amount of electrical energy stored in the apparatus is less than a predetermined threshold amount.

Alternatively the system includes a digital gas pressure gauge configured to measure a pressure of gas stored in a gas storage location in the apparatus, the system includes an electronic controller comprising at least one processor communicatively coupled to the digital gas pressure gauge and at least one computer-readable memory communicatively coupled to the at least one processor, and the electronic controller is configured to prevent actuation or reset of the kill mechanism if the pressure of the compressed gas stored in the gas storage location in the apparatus is less than a predetermined threshold amount.

Alternatively the system includes a digital battery gauge configured to measure an amount of electrical energy stored in one or more batteries in the apparatus, the system includes an electronic controller comprising at least one processor communicatively coupled to the digital battery gauge and at least one computer-readable memory communicatively coupled to the at least one processor, and the electronic controller is configured to prevent actuation or reset of the kill mechanism if the amount of electrical energy stored in the one or more batteries in the apparatus is less than a predetermined threshold amount.

Alternatively the system includes electronic circuitry that utilises one or more temporary electrical energy storage components to temporarily accumulate a charge of electrical energy immediately prior to resetting the kill mechanism or effecting a humane kill of the target creature, and resetting or actuation of the kill mechanism requires a directed discharge of electrical energy from the one or more temporary electrical energy storage components, and further wherein: if the one or more temporary electrical energy storage components does not accumulate a sufficient charge of electrical energy then no electrical energy will be discharged from the one or more temporary electrical energy storage components and directed so as to reset or actuate the kill mechanism.

Alternatively the system includes a pressure switch configured to measure a pressure of gas stored in a gas storage vessel in the apparatus, and either: the pressure switch is configured to be normally closed if the pressure of gas stored in the gas storage vessel is above a predetermined threshold level and electrical current is required to flow through the pressure switch in order to actuate or reset the kill mechanism, or the pressure switch is configured to be normally open if the pressure of gas stored in the gas storage vessel is above a predetermined threshold level and electrical current is required to be prevented from flowing through the pressure switch in order to actuate or reset the kill mechanism.

Alternatively the trap or dispensing apparatus includes at least the following components: a gas storage vessel, an element powered by compressed gas that is operative to humanely kill a target creature, a normally closed pneumatically piloted control valve that controls a flow of compressed gas from the gas storage vessel to the element operative to humanely kill a target creature, a bleed trigger valve that is operative to pilot the normally closed pneumatically piloted control valve, a trigger mechanism responsive to disturbance by a target creature, which is configured to actuate a bleed of compressed gas from the bleed trigger valve upon being disturbed, and a lockout valve mechanism that is responsive to a pressure of the compressed gas stored in the gas storage vessel, and further wherein: if the pressure of the compressed gas stored in the gas storage vessel is below a predetermined threshold the lockout valve mechanism is configured to prevent the normally closed pneumatically piloted control valve from opening, by being configured to do at least one of the following: block a bleed of compressed gas from the normally closed pneumatically piloted control valve through the bleed trigger valve, inhibit movement of the trigger mechanism, or prevent movement of a mechanism of the normally closed pneumatically piloted control valve.

Alternatively the kill mechanism is powered using energy stored in a spring and the kill mechanism is reset using energy from compressed gas and/or electricity stored in the apparatus.

Preferably during the reset of the kill mechanism a ratchet mechanism is used to prevent an actuation or a release of the kill mechanism if the kill mechanism has not been reset to an armed position sufficient to effect a humane kill of the target creature.

Alternatively, a self-locking worm gear is used to hold the kill mechanism in a partially reset position if the device's gas and/or electricity is exhausted before the reset of the kill mechanism is completed and further wherein the device is configured to prevent an actuation or a release of the kill mechanism if the kill mechanism has not been reset to an armed position sufficient to effect a humane kill of the target creature.

Embodiments of systems, devices, and components will now be described with reference to the accompanying figures, wherein like numerals refer to like or similar elements throughout. Although several embodiments, examples and illustrations are disclosed below, it will be understood by those of ordinary skill in the art that the inventions described herein extend beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made.

Terms such as “top”, “bottom’, “upper”, “lower”, “front”, “back”, “left”, “right”, “rear”, and “side” describe the orientation and/or location of portions of the components or elements within a consistent but arbitrary frame of reference which is made clear by reference to the text and the associated drawings describing the components or elements under discussion. Moreover, terms such as “first”, “second”, “third”, and so on may be used to describe separate components. Such terminology may include the words specifically mentioned above, derivatives thereof, and words of similar import.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

Reference to any prior art in this specification does not constitute an admission that such prior art forms part of the common general knowledge.

### BRIEF DESCRIPTION OF THE DRAWINGS

Further aspects of the present invention will now be described by way of example only, and without intending to be limiting, with reference to the accompanying drawings, in which:

FIG. 1 is a cut away side view of one form of solar powered resetting trap with a rotating strike member and a shock absorbing transmission system, part way through resetting;

FIG. 2 is a cut away side view of the device of FIG. 1, at the end of resetting;

FIG. 3 is a cut away side view of the device of FIG. 1, after it has been activated by a creature;

FIG. 4 is a cut away top view of the device of FIG. 1, at the end of resetting;

FIG. 5 is a perspective view of an electric motor, a gear box and part of a strike member resetting mechanism according to a further embodiment;

FIG. 6 is a perspective view of part of a rotating strike member and a solenoid actuator according to a further embodiment;

FIG. 7 is a perspective view of part of a rotating strike member and a mechanical actuator according to a further embodiment;

FIG. 8 is a cut away side view of one form of resetting trap with a piston connected strike member and a shock absorbing transmission system, part way through resetting;

FIG. 9 is a cut away side view of the trap of FIG. 8, at the end of resetting;

FIG. 10 is a cut away side view of one form of resetting trap with a piston connected strike member and a shock absorbing transmission system that includes a flexible, stretchable connector, part way through resetting;

FIG. 11 is a cut away side view of the trap of FIG. 10, at the end of resetting;

FIG. 12 is a cut away side view of the trap of FIG. 8, after it has been activated by a creature;

FIG. 13 is a cut away side view of one form of piston connected strike member with a rack and pinion resetting mechanism, at the end of resetting;

FIG. 14 is a cut away side view of the device of FIG. 13, after it has been activated.

FIG. 15 is a perspective view of one form of resetting trap with a rotating strike member and a shock absorbing transmission system, at the end of resetting;

FIG. 16 is a perspective view of one form of housing for a trap, suitable for mounting on a tree or post;

FIG. 17 is a perspective view of one form of box tunnel for housing a resetting trap;

FIG. 18 is a side view of at least a portion of one form of shock absorbing transmission system with a connecting line in a wound up state;

FIG. 19 is a side view of the system of FIG. 18 with the connecting line unwound;

FIG. 20 is a cut away perspective of a part of the system of FIGS. 18 and 19;

FIG. 21 is a cut away side view of one form of a lockout system fitted to a compressed gas powered apparatus in a set position;

FIG. 22 is a cut away side view of the lockout system of FIG. 21 in a strike position;

FIG. 23 is a perspective view of one form of lockout system comprising a ratchet mechanism fitted to a pulley resetting apparatus for a trap;

FIG. 24 is a side view of one form of lockout system comprising a ratchet mechanism fitted to a rack and pinion resetting apparatus;

FIG. 25 is a cut away side view of one form of lockout system fitted to a pilot controlled diaphragm valve of a trap in the normally closed position; and

FIG. 26 is a cut away side view of one form of lockout system fitted to a pilot controlled diaphragm valve of a trap in an open or set position.

It is noted that the drawings presented herein are not drawn to scale, that not all components or connections are necessarily shown in particular views or perspectives, and that, for the sake of clarity, the attachment of components to frames or housings is not always detailed.

### DETAILED DESCRIPTION

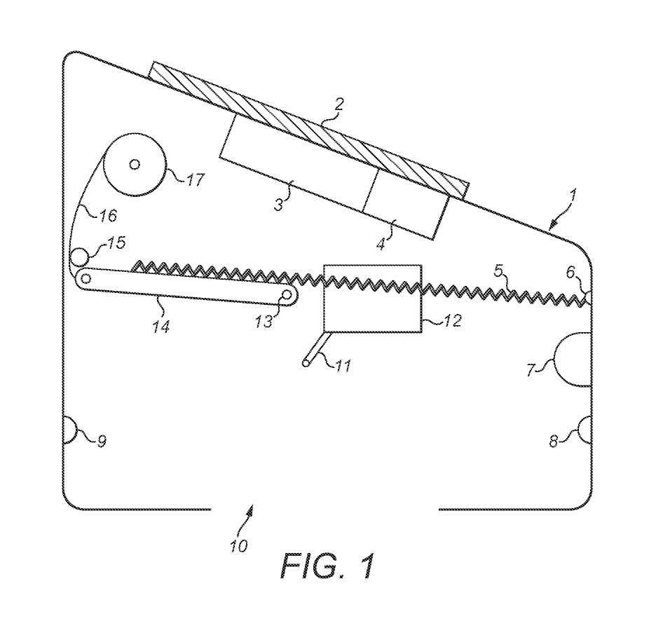

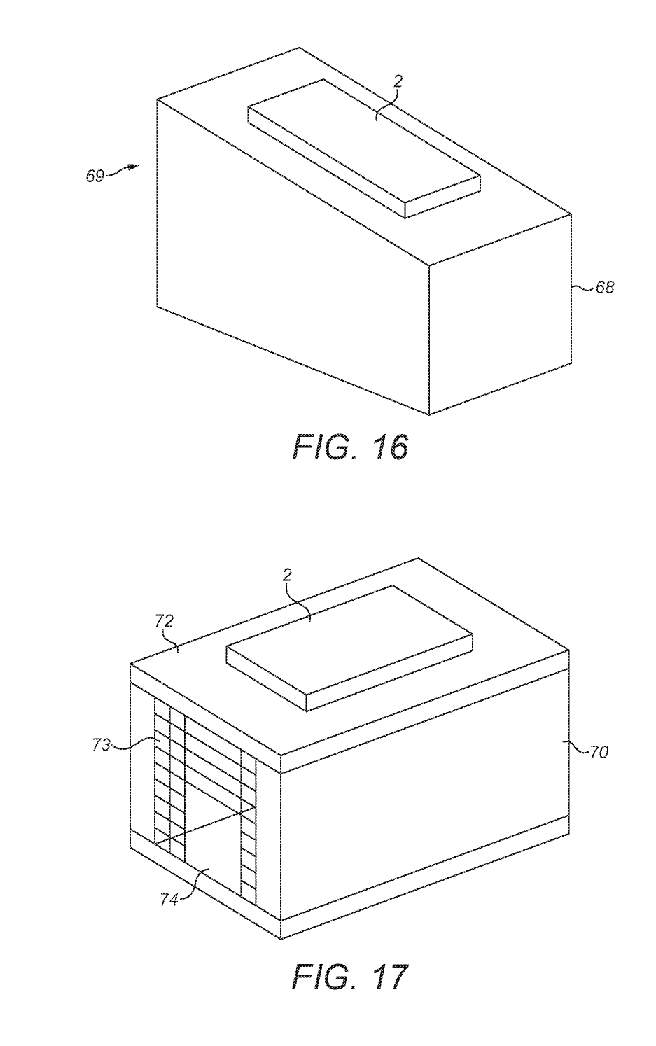

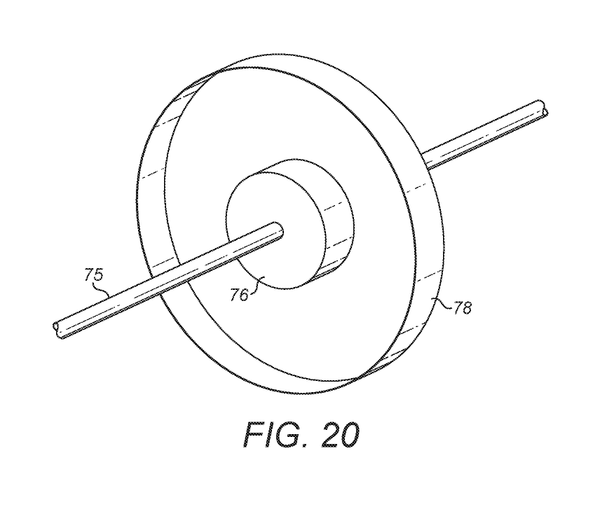

As shown in FIGS. 1 to 26, the present invention relates to a trap configured to kill a target creature, such as a mouse, rat, stoat, weasel, possum, rabbit, bird, toad, lizard, snake or other pest.

The trap 100 comprises a housing 1 that comprises at least one opening 10 for a target creature to at least partially enter the trap 100. The opening 10 may be provided at any suitable location on the trap 100 to allow a target creature to enter the trap through the opening 10. For example, the opening may be provided on an upper surface of the trap, a side surface, or a lower surface of the trap. In one form, the opening may span across more than one surface, such as when the opening is provided at a corner of the housing. In another form, the trap 100 may comprise multiple openings. In one form, as illustrated, the opening 10 is provided at the bottom of the trap 100, on a lower surface of the housing 1.

The housing 1 should be mounted in a suitable way to allow a target creature to at least partially enter the housing through the opening 10. For example, the housing 1 may be attached to a structure above ground level, such as a tree or a post. Alternatively, the housing may comprise legs to allow access to an opening in the lower surface of the housing (i.e. beneath the housing). Another option is to place the housing over a channel to allow access to an opening in the lower surface of the housing.

FIG. 17 shows one form of housing 1 comprising an opening 10 in a side of the housing 1. In this form, the side of the housing 1 comprising the opening has a mesh covering 73 with an opening 10 in it. The opening 10 may be dimensioned to allow a target creature to at least partially enter the housing and to restrict access to the housing 1 for non-target creatures. In one form, the opposite side of the housing may also comprise a mesh covering with or without an opening.

The trap housing 1 comprises a hollow region that may be accessed through the opening(s) 10. The hollow region comprises a lure system 12, comprising a lure outlet 11. The lure outlet 11 is configured to provide a lure to the trap housing, such as by supporting the lure on a supporting surface, dangling the lure or dripping the lure from a spout within the housing. The lure may be any suitable lure for attracting the target creature. For example, the lure may comprise solid or liquid bait food, a smelly substance, a decoy, or sound signal. More than one type of lure may be used. Typically, the lure outlet 11 is located within the housing 1 so that when a lure is provided at the lure outlet 11, the target creature is attracted to the trap and is encouraged to insert at least its head through the trap opening 10 to investigate the lure. The region in which the lure is located is referred to as the strike zone in this specification.

In one form, the interior of the housing may comprise one or more barriers with entrance holes, located between the opening 10 and the lure, to help restrict access to the lure and strike zone for non-target creatures. In another form of trap, the lure outlet 11 and/or the strike zone may be partially or completely outside the housing.

The trap 100 also comprises a strike member 14 configured to strike a target creature within the housing. Different forms of strike member may be used with the trap of the present invention and some of these will be described later in this specification. The strike member 14 is connected to an actuation system that causes the strike member to move from a first position, such as a set position, to a second position, such as a strike position. In one form, the trap may be electronically controlled. In this form, the strike member may be connected (either through a wired or wireless arrangement) to an electronic control system 4 that is configured to activate the actuation system.

The control system 4 may be powered using any suitable energy supply. For example, the control system 4 may be connected to a mains power supply, in some cases. However, more commonly, the trap will be located in remote areas and so the control system 4 may be battery powered. In one form, the control system 4 is powered by rechargeable batteries 3. In some forms, the trap 100 may comprise a solar panel 2 or other energy harvesting device that connects to the control system battery or batteries 3 to recharge the battery/batteries. Where the trap comprises a solar panel, the solar panel may be mounted on or within an upper, outer area of the housing in a position that optimises solar energy collection efficiency. The solar panel may be configured so that its position or orientation is manually adjustable or the position/orientation of the solar panel may be factory set, having regard to the likely area of trap deployment. Where the position/orientation of the solar panel is manually set, the trap may be positioned/orientated so that the solar panel faces in a direction where it is likely to receive the most light.

In one form, the trap housing 1 may comprise an access port, such as a lid or other recloseable opening, that allows access to key features of the trap 100 (such as the battery/batteries 3) to facilitate maintenance and servicing of the trap 100. The housing lid 72 may be mounted to the housing 1 by any suitable attachment system, such as by hinges, pivot points, or the like. In another form, the lid 72 may be configured to sit on the housing 1 and may be completely removable from the housing, by lifting the lid off the housing 1.

The trap may comprise a trigger configured to activate the actuation system to move the strike member from a first position to a second position. The first position may be a set position, in which the strike member is ready to strike, and the second position may be a strike position, in which the strike member has been triggered to strike a target creature. Therefore, the strike member may be considered to be in the strike position at the time at which it strikes a target creature or after it has struck a target creature and it is at its point of maximum reach.

In one form, the trap comprises a mechanically operated trigger configured to activate an actuation system to move the strike member from a set position to a strike position. For example, the trap 100 may be configured to include a hair trigger, wire trigger, pedal, or the like, that is caused to move when contacted by a target creature. Upon movement of the trigger, the actuation system may be activated to move the strike member. In another form, the trigger itself is the actuation system.

In another form, the trap 100 comprises at least one electronic trigger, such as a sensor, that communicates with the electronic control system to cause the actuation system to move the strike member from a set position to a strike position. For example the trap may comprise at least one sensor to detect when an object (such as a target creature) has entered the trap housing 1. In one form, the trap 100 comprises two sensors 8, 9 that produce a signal when an object enters the trap housing 1 and is in a location within the housing where the strike member will contact the object upon activation of the strike member 14.

Any suitable sensor(s) may be used with the trap of the present invention. For example, one or more sensors could be configured to produce a signal based on: image recognition (such as visible light, infrared, thermal imagery, footprint image, head image, body image, or the like); or the breaking of a light beam (such as a visible or infrared beam); electrical resistance or capacitance; weight; pushing or pulling by a target creature; smell; noise, movement patterns; or the like. For example, the trap may comprise one or more sensors in the form of motion sensors, strain gauges, passive infrared detectors, paired infrared transmitters and receivers; olfactory sensors, resistive sensors, conductive sensors, capacitive sensors, microphones, image capture devices or any other suitable form of sensor(s).

Each sensor is connected to the control system, either through a wired or wireless connection, so that the control system is configured to receive signals from the sensor. The control system may be configured to cause the sensor(s) to test the sensing environment continuously or at predetermined time intervals. In a preferred form, each sensor is caused to sense the environment at predetermined time intervals (such as every n seconds) to minimise power consumption. The time period for n may be any suitable time period, such as 3 seconds, 10 seconds, 25 seconds, for example. In another form, only one sensor is used to sense the environment at predetermined time intervals and, upon detecting the presence of a creature, causes other sensors to become active. This form further minimises power consumption.

Signals produced by triggers or sensors do not necessarily directly actuate the trap. Rather, these signals may be transmitted to the trap's control system for processing. The trap's control system may issue actuation signals based on the sensor input and decision making algorithms hardwired or programmed into the control system. In some forms, the control system may be a system of switches or integrated circuits; in other forms it may comprise a micro-processor with a computer readable memory containing instructions.

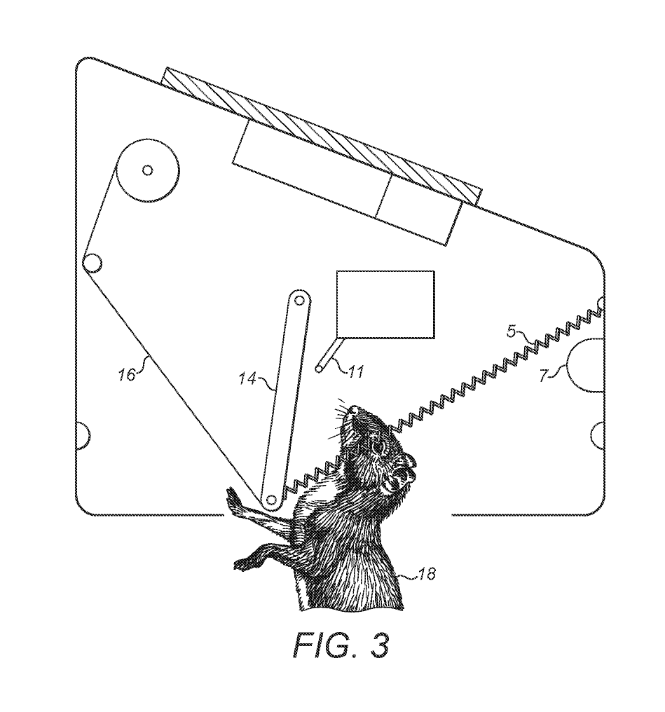

FIG. 3 shows a target creature 18 activating a trigger, in the form of a pair of sensor components 8, 9. In one form, the sensor components comprise a paired infrared transmitter 8 and a receiver 9. When the trap is in a ready state, the sensor components 8, 9 are operating. Where an object in the strike zone, such as a target creature, breaks an infrared beam passing between these sensor components 8, 9, the infrared receiver 9 generates a change in signal state that is received by the electronic control system 4, which causes the actuation system to activate the strike member 14.

In an alternative form, mechanical triggering can be used instead of sensors and electronic strike member activation. For example, the trap may comprise a moveable lure holder configured to pull and rotate the strike member 14 from the over-centred set position to the strike position, in response to being moved by a target creature.

The control system is connected to an actuation system of the strike member so that upon receiving a signal from the sensor(s), the control system causes the actuation system to activate the strike member to strike the object/target creature within the trap housing 1.

In some forms, the control system may be programmed to only cause the strike member to strike after predetermined decision rules are satisfied. For example, the control system may be programmed to only activate the trike member after a predetermined number of signals are received from each sensor within a predetermined time period; or after a predetermined number of signals are received from a predetermined number of sensors within a predetermined time period. In yet another form, the control system may be configured to cause the strike member to strike after a predetermined number of signals are received from predetermined sensors in particular locations and within a predetermined time period. For example, each sensor may be allocated a sensor ID that is linked with the sensor signal. A first sensor having sensor ID 8891 may be located within the housing 1 at one end of the trap 100 and a second sensor having sensor ID 8893 may be located within the housing 1 at an opposite end of the trap 100, for example. The sensor ID's are entered into the control system. Therefore, when an object is between the two sensors, both sensors 8891 and 8893 will send a signal to the control system either substantially simultaneously or within a short time period, such as 10 seconds, for example. The control system may then activate the strike member actuation system if the control system is pre-programmed to activate the actuation system upon receiving signals from sensors 8891 and 8893 within the predetermined time period.

The control system typically comprises a clock for counting the time period between sensor signals. In a preferred form, the control system comprises a programmable micro-controller with an inbuilt clock.

In some forms, the control system may be programmed so that the actuation system either is or is not activated during daylight. In this form, the trap may comprise a light meter that communicates with the control system so that the control system may determine whether or not the trap is in daylight. This configuration may be used to reduce the risk that the trap could kill non-target creatures. In another form, the control system (with clock) may be programmed so that the actuation system is not activated to cause a strike within the first x hours of being powered on after deployment. The initial time period x may be any suitable number of hours, such as 1 hour, 1.5 hours, 24 hours, 29 hours, 48 hours, 96 hours, and so on. In this configuration, the trap with lure may be used to encourage target creatures to visit the trap.

The decision rules programmed into the control system may include any suitable numerical ranges for variables, wherein sensor readings, time periods, etc. must fall below, within, above or outside of such ranges.

The trap of the present invention may be configured to comprise any suitable form of strike member that can be actuated to cause a fatal strike to a target creature, such as a strike to the creature's head. For example, the strike member may be a pivoting member, a pulling member, or a pushing member, such as where movement of the strike member is driven by a piston-like arrangement. The strike member may be configured to hit the target creature with such force as to kill the creature, preferably quickly in order to be as humane as possible. National and international standards prescribe animal welfare standards for humane trapping.

In one form, the trap may be configured to provide both a strike member and a clamping surface. The clamping surface may be configured to prevent a target creature from avoiding a strike by the strike member. In some forms the strike member and clamping surface may be configured so that upon a strike, the strike member hits or otherwise compresses the target creature against the clamping surface for a period of time to help ensure that the target creature is killed. It should be noted that the strike member 14 and the clamping surface do not have to meet for this to occur. Instead, the strike member 14 may stop short of or by-pass the clamping surface. Typically, the clamping surface is located substantially opposite the clamping surface of the strike member when the strike member is in the strike position. The clamping surface may be any suitable surface, such as an inner surface of the housing 1 opposite the strike member 14 and against which the strike member 14 may compress the target creature. Alternatively, the trap 100 may be configured to comprise a clamping surface between the housing wall and strike member. For example, the trap may comprise an interior wall or partition that forms a clamping surface. In one form, an edge of the opening 10 may form a clamping surface against which the strike member 14 is configured to compress the target creature.

The trap of the present invention may also be configured to comprise any suitable actuation system for causing the strike member to strike, so that the strike member is caused to move from a first, set position to a second, strike position. In some forms, the actuation system may also be configured to reset the trap from the strike position to the set position. In this form, the actuation system also comprises a resetting system. In some forms, at least some components of the actuation system may form part of the resetting system.

Different forms of strike member and actuation systems that may be used with the trap of the present invention will now be described.

In one form, as shown in FIGS. 1 to 7, a pivoting strike member 14 is configured to rotate about an axis 13 to move from a first position to a second position. For example, the strike member 14 may be configured to hinge or pivot about an axis 13. In one form, the strike member may be pivotally mounted on a pair of pivot shafts 13, such as bolts, rods, or the like that are located on opposing sides of the strike member 14. In this configuration, the strike member 14 is able to rotate around these pivot shafts. In another form, the strike member may comprise a bore or one or more brackets configured to receive an axle in a configuration that allows the strike member to rotate about the axle to move from a first position to a second position.

The strike member may be biased to a particular position, such as a set position. In this configuration, the strike member may be more readily reset to its set position. Alternatively, the strike member may be biased to a strike position, which may provide the strike member with additional strike force with which to strike a target creature.

The strike member may be of any suitable shape and dimensions to fit within the housing and strike a target creature. For example, the strike member may be in the form of a substantially solid panel, a bar, a piston-like rod, or the like. The strike member may also be biased to the set position or to the strike position.

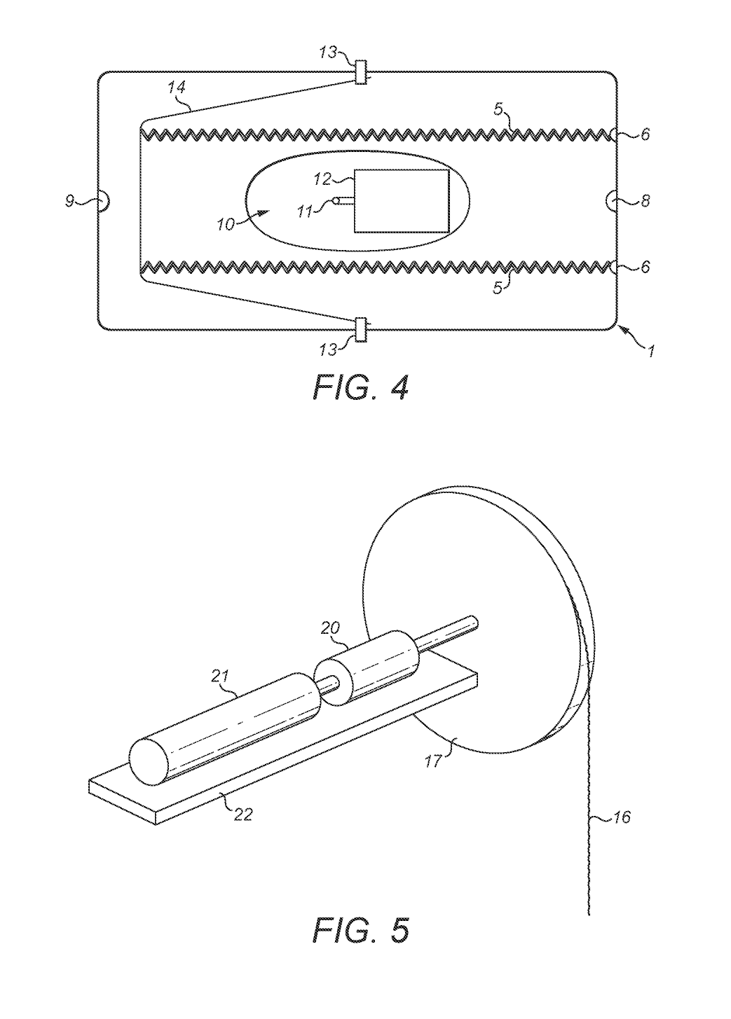

In one form, as illustrated in FIGS. 1 to 7, the pivoting strike member may comprise a substantially U-shaped bar. The two distal ends of the U may pivotally engage with an axis so that the U-shaped bar is configured to hinge or rotate about its ends, as shown in FIGS. 1 to 3. One or more springs or other biasing members, such as bungee cords for example, may be connected to the U-shaped strike member 14 and a support structure (such as the trap housing or a frame within the housing), to bias the strike member 14 to a set position. In one form, as seen best in FIG. 4, two springs 5 are attached to the U-shaped strike member 14. One end 6 of each spring 5 may be attached to the housing 1 and the other end may be attached to the strike member, preferably at or near a middle region of the strike member lying between the arms of the U. In the set position, the springs are stretched and the strike member may be over-centred. For example, if the strike member is in a centred position, the springs would be at a level of stretch A, which is the maximum level of stretch for all possible strike member positions. When the strike member is rotated further away from the strike position so as to be over-centred in the set position, the springs would be at a lesser level of stretch B, so A>B. In this over-centred configuration, the springs bias the strike member 14 to press against at least one backstop 15 in the set position.

Various forms of actuation system of the trap 100 of the present invention will now be described, but it should be appreciated that other forms of actuation system may be used to move the strike member from a set position to a strike position without departing from the scope of the present invention.

In one form, the control system activates the actuation system, which causes the pivoting strike member 14 to rotate about the axis 13 and overcome the biasing force of the spring(s) 5. Once the pivoting strike member 14 is activated and rotates past the centred position, the springs 5 then pull the strike member 14 towards the area 6 where the spring(s) is/are attached to the support structure. In one form, at least one strike stop 7 is located near the area of spring attachment 6 and the strike member is caused to rotate/hinge toward the strike stop 7. The path of the strike member 14 passes into or through the strike zone as it reaches the strike position. Therefore, when an object, such as a target creature, is in the strike zone, the pivoting strike member 14 will hit the object. Preferably, the spring(s) 5 is/are selected to have sufficient strength to rotate the strike member 14 at sufficient speed to kill a target creature in the strike zone.

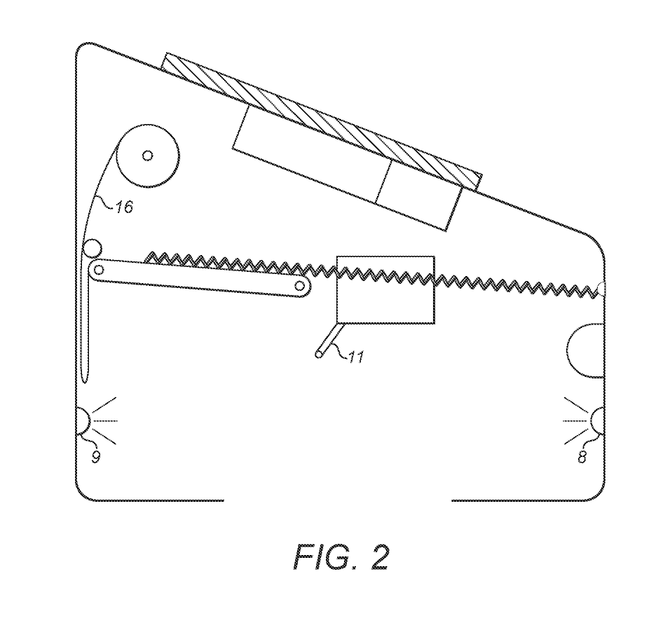

A target creature will typically be killed by the momentum of the strike member 14, the clamping force of the strike member 14 against a clamping surface, or a combination of both of these effects. In one form, the trap may be configured so that the clamping force effect is prolonged, such as for several minutes for example, in order to be more effective at killing the target creature, before the strike member is returned from the strike position shown in FIG. 3 to the partially reset stage of FIG. 1 and then to the fully reset stage of FIG. 2 (i.e. the set position).

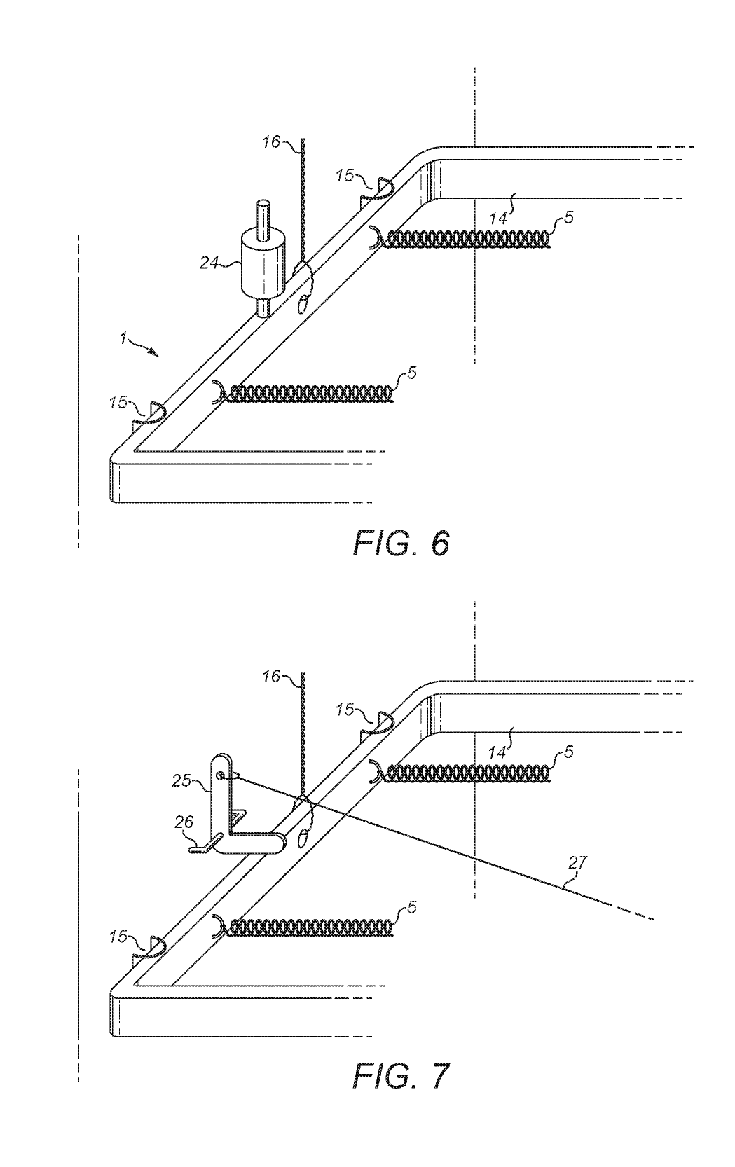

FIG. 6 shows a portion of one form actuation system for a pivoting strike member in a powered resetting trap. The pivoting strike member is shown in an over-centred set position and resting against two backstops 15 attached to or forming part a support structure, such as a frame or housing 1 of the trap. The actuation system comprises a solenoid 24 that comprises an extendable and retractable actuating arm. The solenoid 24 is connected to the control system 4, which is configured to send an activation signal to the solenoid when the control system receives one or more sensor signals that satisfy the strike member actuation decision rules. Upon receiving the activation signal from the control system 4, the solenoid 24 may cause its actuating arm to extend. The solenoid may be located on a support structure (such as a frame, the housing 1 or other structure) near the strike member 14 and may be positioned so that when the actuating arm extends, the arm pushes against the strike member 14. The strike member may be so finely balanced in the over-centred position that only a slight movement trips the strike member to the strike position. Therefore, the push of the extending actuator arm of the solenoid 24 urges the strike member 14 to pivot downwardly out of its over-centred position and past the centred position. Once the strike member rotates past the centred position, the pulling force of the spring(s) 5 will pull the strike member quickly toward the spring attachment area 6 of the trap housing 1 or the one or more strike stops 7. Other suitable electronic actuation systems may be used to cause an actuating member to push or pull the strike member toward the strike position without departing from the scope of the invention.

FIG. 7 shows another form of strike member actuation system for use with a trap of the present invention having a pivoting strike member. In this form, the actuation system for the strike member is mechanically activated. The embodiment shown in FIG. 7 is similar to that shown in FIG. 6, but the solenoid 24 is replaced with a mechanically activated lever mechanism comprising a lever 25, which is pivotally connected to a bracket 26 or any other suitable form of connection that allows the lever to pivot. The bracket 26 may be attached to a support structure, such as the trap housing 1 or a frame within the trap housing 1. The lever mechanism also comprises a control line 27, which may be a wire, line, cord or the like. One end of the control line is connected to the lever 25. The other end of the control line 27 is connected to a trigger mechanism, such as a bait hook, a bite block, a treadle plate, or the like. In this embodiment, the strike member 14 is activated by a target creature causing the control line 27 to be pulled as a result of the creature interacting with the trigger mechanism. Because the lever 25 is configured to pivot about the bracket 26, when a target creature interacts with the trigger mechanism so that the mechanism pulls on the control line 27, the lever 25 is caused to pivot and to urge the strike member 14 from the backstop(s), past its over-centred position and toward the one or more strike stops 7. Once the strike member 14 has moved past its over-centred position, it is pulled toward the one or more strike stops 7 by the spring(s) 5 or other biasing member(s). Under this embodiment, activation of the strike member can be purely mechanical, with no electronics required. The trap may also include a mechanical resetting system in which the strike member resetting may be controlled by using one or more switches, such as limit switches, to avoid the need to use a micro-processor in this or other embodiments.

In one form, the actuation system may also comprise a resetting system configured to reset the strike member by moving the strike member from the strike position to the set position. For example, in one form, the strike member 14 is connected to a connecting line 16, as shown in FIG. 6. One end of the connecting line 16 may be directly or indirectly attached to the strike member and the other end may be directly or indirectly attached to a resetting system. The connecting line 16 may comprise a rope, cable, strap, belt, chain, or the like. The thickness and material of the connecting line 16 may be selected to meet the requirements for the trap, such as corrosion resistance, or high breaking strength, for example. Alternatively or additionally, the thickness and material of the connecting line 16 may be selected to reduce the risk of the connecting line 16 becoming tangled. To further reduce this risk, the trap may comprise one or more guards or guides to guide the position of the connecting line 16.

The connecting line 16 may be configured to be wound in by the resetting system 17 by overcoming the load imposed by the bias of the biasing members or spring(s) 5. The resetting system 17 may be any suitable system for retracting the connecting line from an extended position to a stowed position. For example, the resetting system may comprise a retractor, such as a pulley, cog, wheel, drum, or the like, around which the connecting line may be wound to a stowed position or from which the connector may be unwound to the extended position. In some forms, the retractor may comprise a rotating member, such as a rotating pulley, wheel, cog, or drum for example.

The resetting system may further comprise a motor, such as an electric motor. Where an electric motor is used, the motor may be connected to the control system, which may be programmed to activate the resetting system by causing the motor to rotate the retractor to wind the connecting line 16 in and out when required. For example, the motor may be driven in a first direction to wind the connecting line in and may also be driven in a second, reverse direction to unwind the connecting line. In one form, the motor may comprise a gearing system configured to reduce the revolutions per minute from the motor to a final drive member that connects to the retractor to cause the retractor to rotate. In one form, the gearing system comprises a gear box, such as a planetary gear box or a worm gear box. In one form, the gear box is integrated with a body of a motor.

In one form, the resetting system may be configured to provide a shock absorbing transmission system. In this form, once the strike member is over-centred in the set position, the retractor, such as a pulley 17, may be rotated in a reverse direction to allow the connecting line 16 to extend. This configuration provides the connecting line 16 with slack, as shown in FIG. 2, to prevent the impact force, generated when the strike member impacts a target creature, from being transmitted to at least some parts of the resetting system and causing damage (particularly to the motor, gearing system or other sensitive components). For example, when the strike member is activated, the slack in the connecting line prevents a sudden and strong pull being placed on the retractor and the components connected to the retractor, such as the motor and gearing system. In other words, the slack in the connecting line 16 may be taken up without transmitting a shock load or impact force (when the strike member hits an object) to the resetting system.

Therefore, for a strike member to be ready in the set position of a trap having a shock absorbing transmission system, as described above, the strike member will be first returned to its over-centred set position and then the connecting line 16 will need to be unwound to slack before the strike member 14 is ready to activate.

FIG. 5 demonstrates a pulley configuration according to another form of resetting system in a powered resetting trap. The pulley 17 is mounted on a drive shaft, which may be mounted to rotate in bearings or the like, as would be readily apparent to a person skilled in the art. The drive shaft is coupled to a motor and gear box, which together cause the drive shaft, and therefore the pulley, to rotate when the motor is operating. In this form, the gear box 20 is coupled to the pulley 17 via the drive shaft and an electric motor 21 is coupled to the gear box 20. The gear box 20 and the electric motor 21 are mounted on a frame 22, which may be connected to or be part of the trap housing. The specifications of the gear box 20 and the electric motor 21 are determined by any contingency margin, the available power supply, and the resistance to be overcome to move the strike member from the strike position to its set position. That resistance will be affected by the power of the springs used in the trap and the mechanical leverage inherent in the trap design. Where a low voltage electric motor drawing a relatively low current is being used, in conjunction with powerful trap springs, a high gearing ratio gear box is required to give a low final drive speed.

Optionally, a clutch may be connected between the pulley 17 and gear box 20 or between the gear box 20 and electric motor 21. Any suitable type of clutch may be used, such as a slipper clutch, a spring wrap clutch, a dog clutch, a friction clutch, a cone clutch, an electromagnetic clutch, a centrifugal clutch, or a toothed wheel or cog and one or more pawls, for example.

One end of the connecting line 16 may be secured to the pulley 17 and the other end may be secured to the strike member 14, at or near the free, non-hinged end of the strike member. To reset the strike member 14 from the strike position to the set position, the connecting line 16 is wound onto the pulley 17 by causing the motor to rotate the drive shaft and therefore the pulley 17. Once the strike member has reached its set position, the motor may be operated in reverse so that the pulley 17 rotates in reverse and connecting line 16 is at least partially unwound to hang or lie slack.

The trap may further comprise limit switches or the like to signal to the control system 4 that the retractor or pulley 17 has reached, or has almost reached, a fully wound in or unwound position. The control system may then stop the operation of the motor 21.

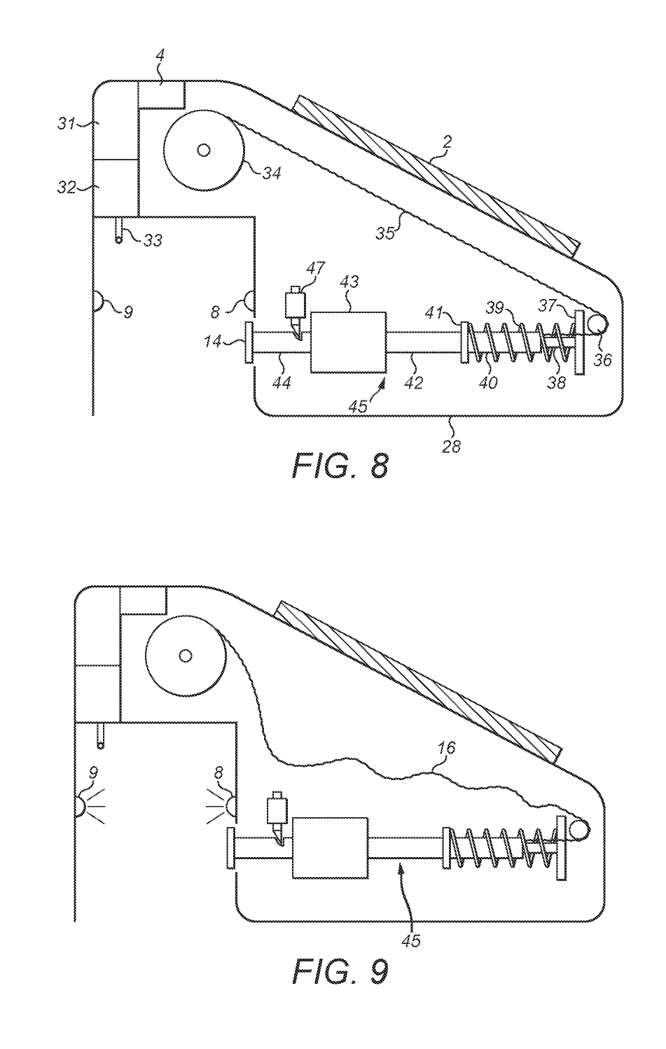

FIGS. 8 to 12 show other forms of resetting traps comprising another form of strike member with a shock absorbing transmission system. In these forms, the strike member is connected to a piston, powered by a compression spring 39 and a shock absorbing transmission system. In one form, the strike member comprises a strike surface that is integral with the piston.

In these forms, a strike member 14 is connected to, or is part of, a piston rod 44 of a piston. The piston rod may comprise first 40, second 42 and third 44 portions that together form the length of the piston rod. The piston rod is configured to slide inside a piston cylinder 43. Part of the length of the piston rod can extend from piston cylinder 43, as the piston rod and strike member move toward the strike zone, and retract, as the piston and strike member retract to the set position. The piston cylinder 43 may be attached to a support structure, such as the trap housing 1 or a frame within the housing. A flange 41 or the like is fitted to the piston rod between the first and second portions 40, 42. One end of the compression spring 39 presses against a surface of the flange and the other end of the compression spring 39 acts against a fixed member 37. The flange 41 also provides a stop that prevents the piston rod from overextending and hence prevents the strike member 14 from hitting a clamping surface and causing damage to either or both the strike member and clamping surface. A compressible element may be provided between the piston cylinder 43 and the flange 41 to cushion the movement of the piston 45 at the end of its stroke. A guide member may be provided to keep the compression spring 39 in place, particularly when the piston 45 is extended near the end of its stroke. In one form, the guide member may take the form of a rod 38 attached to the fixed member 37 and sleeved inside an end of the piston 45. In another form, the guide member may be a tube attached to the fixed member 37 and sleeved outside the end of the piston 45.

A latch 47 may be configured to engage the piston 45 to hold the piston and therefore the strike member 14 in the set position. The latch 47 may be of any suitable configuration to engage with and disengage from the piston. In one form, the latch may in the form of a solenoid latch configured to receive an activation signal from the electronic control system. The piston 45 may comprise a latch receiver, such as a cavity, hook, or other member that is configured to engage with a projecting locking arm of the latch. The latch may also be configured to disengage from the piston 45 to release the piston and therefore the strike member 14 from the set position. In the set position, the compression spring 39 presses against the flange 41 to bias the flange toward the piston cylinder 43 and hence to bias the strike member 14 toward the strike zone or opposing clamping surface.

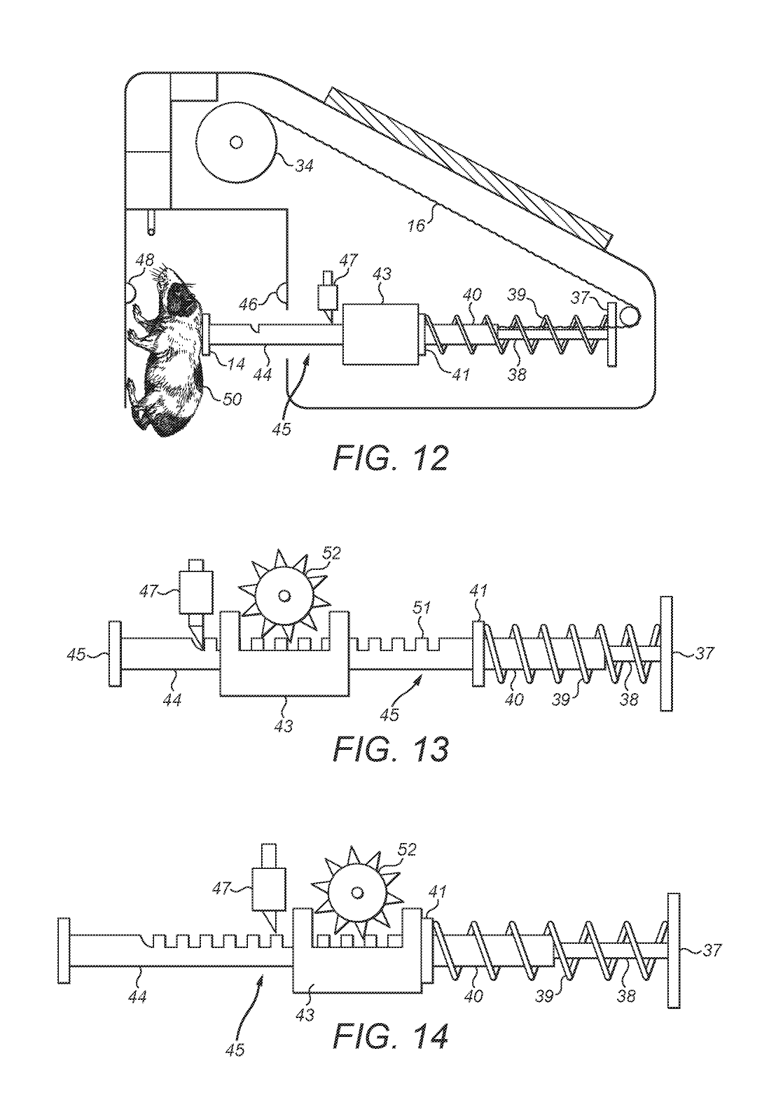

In one form, when a target creature enters the trap and breaks an infrared beam between sensor components 8 and 9, or otherwise causes a trigger signal to be received by the electronic control system 4, the control system 4 activates the strike member actuation system by sending a signal to release or retract the latch 47 from the piston 45. Upon receiving the signal, the latch 47 may be configured to release or retract its locking arm, thereby disengaging from the piston. Releasing or retracting the locking arm of the latch 47 allows the compression spring 39 to push the flange 41 toward the piston cylinder 43 and hence to push the strike member 14 toward the strike zone or clamping surface to strike the target creature 50. FIG. 12 shows a target creature 50 that has been hit by the strike member 45 of trap. Preferably, activation of the strike member 14 causes the slack in the connecting line 35 to be taken up without transmitting a shock load to the actuation system of a magnitude that would cause damage those components.

The trap may also be configured to reset itself using a resetting system similar to that described above. In this form, one end of a connecting line 16 is attached to the piston of the strike member. Another end of the connecting line is attached to a retractor, such as a pulley or the like. In the embodiment illustrated, the retractor is in the form of a pulley 34. In a preferred form, a sheave 36 is provided between the piston rod end 40 and the retractor. In this form, the connector passes around the sheave 36 and then to the retractor 34. The sheave 36 may be configured to spin freely or may comprise a non-moving low friction surface. The pulley 34 is configured to wind the connecting line in and out and is driven by an electric motor and, optionally, a gearing system, such as a gear box. Therefore, to reset the trap, the electronic control system activates the motor to rotate the pulley 34 in order to wind up or retract the connecting line. The connecting line pulls on the piston 45, causing the piston to retract. Once the piston is retracted, the latch 47 engages with the piston to latch the piston in the set position. The latch 47 may be spring loaded so as to engage with the piston automatically as soon as the piston is in the appropriate position.

In one form, the trap may comprise a shock absorbing transmission system, as described above. In this form, once the piston is latched in the set position, a switch or sensor may notify the control system. The control system then causes the motor to operate in reverse so that the retractor or pulley 34 is operated in a reverse direction to introduce slack into the connecting line 16, as shown in FIG. 9.

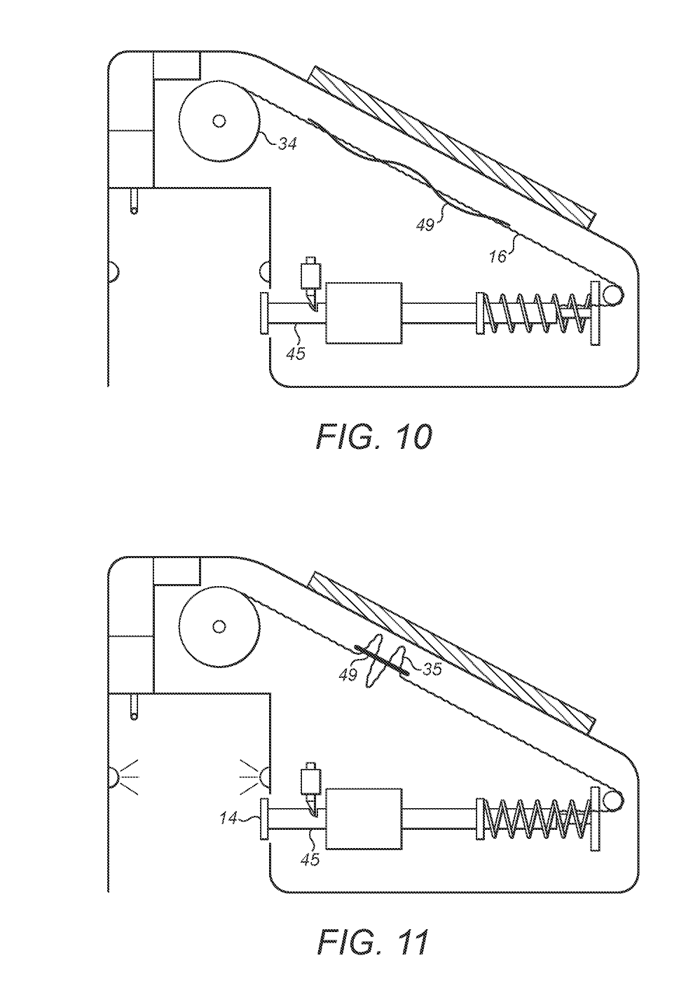

In another form, as shown in FIGS. 10 and 11, the connecting line 16 of the shock absorbing transmission system of the traps shown in FIGS. 8 and 9 may also be at least partially stretchable, such as by being formed of a stretchable material or by comprising at least one stretchable region. For example, the connecting line 16 may be connected to an elastic region 49 to allow the connecting line to be at least partially stretched. The connecting line is fully stretched, as shown in FIG. 10, when it is being wound in to reset the piston 44. The connecting line may also be fully stretched when the strike member is in the strike position. In the fully stretched position, the elastic region 49 of the connecting line 16 stretches to allow the connecting line 16 to be pulled tight. Where the trap comprises a shock absorbing transmission system, as soon as the reverse operation of the retractor introduces slack into the connecting line 16, the elastic region returns to a non-stretched state 49, as illustrated in FIG. 11. The elastic region 49 of the connecting line 16 therefore allows the slack in the connecting line 16 to be reduced or removed in a controlled way—to create a ‘stretchable slack’.

The elastic component or region of the connecting line 16, which allows the connecting line to be at least partially stretchable, may comprise any suitable stretchable material, such as rubber, elastane, or a coiled material, for example. Other configurations may also be used to reduce or remove slack in the connecting line. For example, slack in the connecting line may be controlled by adding or incorporating weight to the connecting line or by the use of tensioning devices that pull at the connecting line.

In another form, as shown in FIGS. 13 and 14, the trap of the present invention comprises an actuation system comprising a rack and pinion resetting mechanism. Again, in this form, the strike member is connected to or is part of a piston 45 powered by a compression spring. This embodiment is similar to the embodiments shown in FIGS. 8 to 12, but one side of the piston 45 comprises teeth that engage with a cog 52 in the manner of a rack and pinion arrangement. An electric motor, a gearing system, such as a gear box, and a clutch or a shock absorbing transmission system may be connected together and operated to rotate the cog 52, causing the piston 45 to be retracted to reset the trap.

When a target creature enters the trap housing 1 and triggers the control system 4 to activate the actuation system, the latch 47 (such as a solenoid with an actuating arm that acts as a latch) of the actuation system is automatically retracted from the piston 45 by the control system 4, as shown in FIG. 14. Once the latch has disengaged from the piston 45, pressure from the compression spring 39 pushing against flange 41 causes the flange 41 to move toward the piston cylinder 43 and therefore causes the strike member to move toward the strike zone or clamping surface to strike the target creature.

Extension and retraction movement of the piston causes the cog 52 to rotate as the cog engages with the rack of the moving piston. In the absence of a clutch or a shock absorbing transmission system, this could damage the electric motor and/or the gear box. Accordingly, a clutch or shock absorbing transmission system is desirable, which may preferably be located between the gear box and the cog 52. In another embodiment, the clutch may be configured to move the cog 52 so that the cog 52 is either engaged or disengaged with the rack of the piston.

Once the strike member 14 is retracted to the set position, the solenoid latch 47 is re-engaged with the piston. In one embodiment, the trap may comprise a limit switch or the like that sends a signal to the control system 4 that the strike member 14 has been returned to the set position. Upon receiving the signal from the limit switch, the control system may send a signal to the solenoid latch to cause the locking arm of the latch 47 to extend and engage with the piston 45. In another embodiment, the locking arm of the latch may be spring loaded to automatically engage with the piston once the piston is in an appropriate position.

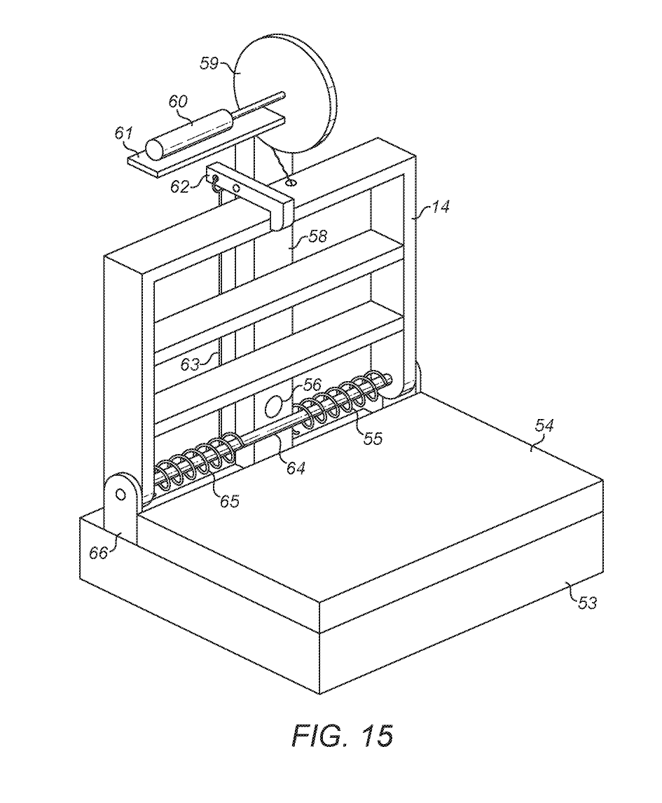

In another form of trap, as shown in FIG. 15, a target creature is enticed to insert its head between the strike member 14 and the clamping surface 54 to investigate a lure 56 dispensed from a lure system. The strike member is urged toward the clamping surface by two torsion springs 55 and 65. If the trap is deployed in a tunnel, a lure can be positioned so that the trap is between a tunnel entrance and the lure with the strike member 14 being activated as a target creature crosses the clamping surface 54 to reach the lure.

In this embodiment, the strike member 14 is mounted to rotate around an axle 64 that is held by bearings 66 at either side of the trap. The strike member 14 is latched in a set position by a latch 62. In this particular embodiment, the latch is attached to a cable or a rod 63 and clamping surface 54 is a treadle plate configured so that a target creature, of a sufficient weight, will cause the latch to release the strike member 14 and allow it to progress toward the clamping surface 54 under the force of the torsion springs 55 and 65.

The strike member 14 may be returned to the set position by a cable attached to the strike member 14 and wound onto a retractor, such as a pulley 59. The pulley 59 is driven by an electric motor 60 and a gearing system (such as a gear box) mounted on a drive support frame 61. Preferably, the actuation and resetting system also comprises a clutch or shock absorbing transmission system that are connected together and operable so as to rotate the pulley 59. Once the strike member 14 is retracted to the set position, the latch 62 is re-engaged. In one form, this is encouraged by a spring that connects to the latch 62 and a frame 58. The drive support frame 61 and the pulley 59 are also attached to the frame 58.

In the embodiment shown in FIG. 15, the various trap components are mounted on a trap base 53 that can house other trap components, such as one or more batteries, a controller, a lure dispensing system, or the like.

Another form of shock absorbing transmission system is shown in FIGS. 18 to 20. In this form, an inner drum 76 is fixed to or is integral with a rotatable axle 75. The axle 75 is connected to a gear box connected to an electric motor. Alternatively, the inner drum 76 may rotate freely on a fixed axle 75. In this form, the inner drum is connected to the gear box, which in turn is connected to an electric motor. In either embodiment, rotation of the electric motor causes rotation of the inner drum 76. The gear box may be used to slow the rotational speed of the inner drum compared to the rotational output speed of the motor. In other forms, the inner drum may be connected to the motor without the need for a gearbox.

An outer drum 78 may also be configured to rotate around the axle 75. The outer drum may be connected to or form part of the strike member resetting system. For example, the outer drum 78 may be attached to (via a belt, a chain, or the like) or integral with the retractor or pulley 17 as shown in FIG. 1, 8, or 15; or the cog 52 as shown in FIG. 13.

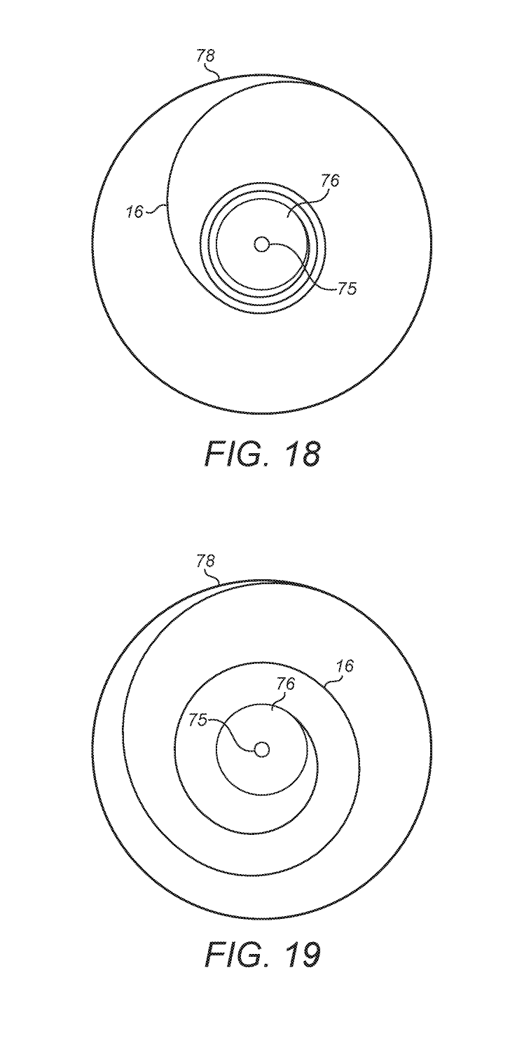

One end of a connecting line 16 connects to the inner drum 76 and the other end of the connecting line 16 connects to the outer drum 78. When the electric motor is operated to rotate the inner drum 76 in one direction, such as a counter-clockwise direction, the connecting line 16 initially winds onto the inner drum 76. Once the connecting line 16 has wound onto the inner drum 76 sufficiently to take up any slack, the connecting line 16 transmits power from the motor to rotate the outer drum 78 in the same/counter-clockwise direction. The rotating outer drum 78 drives the strike member resetting system to reset the strike member to the set position. Once the strike member is reset, the control system may cause the electric motor to operate in the reverse direction, such as the clockwise direction, thereby causing the inner drum 76 to also rotate in the reverse/clockwise direction. This reverse rotation unwinds the connecting line 16 from the inner drum 76 to introduce slack in the connecting line 16 between the inner drum 76 and the outer drum 78, as shown in FIG. 19. Both sides of the inner and outer drums 76, 78 may be at least partially enclosed to contain the slack of the connecting line 16. In some forms, the connecting line may be made from webbing, a steel spring strip, plastic strapping, or any other suitable material of a similar width to the drums to minimise the risk of the slack in the connecting line 16 tangling with other parts.

When the strike member is activated, the outer drum 78 is rapidly rotated in a second direction, such as a clockwise direction. The slack in the connecting line 16 is therefore rapidly wound onto the inner drum 76 without the inner drum 76 being rotated with a shock load from the strike member that might otherwise damage parts of the resetting system, such as the gear box and/or the electric motor.

In a further form, the connecting line 16 shown in FIGS. 18 and 19 passes through the outer drum 78, without being fixed to the drum and is connected to the strike member. In this form, the outer drum 78 is secured in a fixed position and does not rotate. This embodiment also allows for slack of the connecting line 16 to spool between the inner drum 76 and the outer drum 78, but some slack may also arise outside of the drums. In another form, there is no outer drum 78 and the slack in the connecting line 16 is contained by the trap's housing.

In one form, the trap of the present invention may comprise a lockout system to prevent the actuation system of the trap from triggering a strike when the trap has an insufficient energy level in its power supply to kill the target creature in a quick, humane manner or when the energy level is below a particular threshold. Such lockout systems may be particularly suitable for compressed gas powered traps, but may also be suitable for electrically powered traps. In other words, the energy supply for the trap may be compressed gas or electricity.

The lockout system may comprise a lockout member, which may be configured to be moveable between an open position, in which gas can flow to the actuating system to enable the actuating system to activate the strike member, and a closed position, in which the lockout member restricts the flow of gas to the actuating system to prevent the actuation system from activating the strike member when the gas supply pressure is below a particular threshold or is insufficient to strike and kill a target creature humanely.

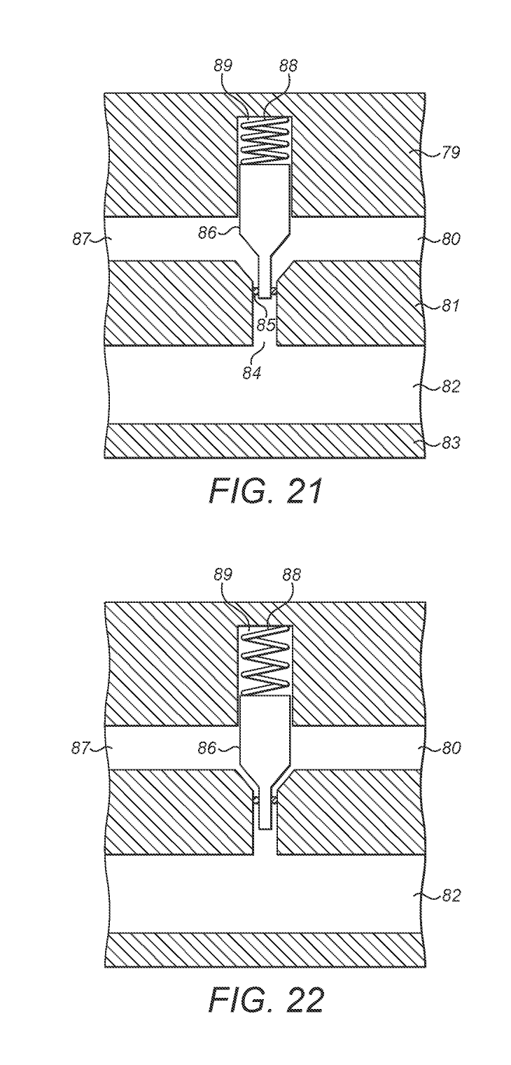

One form of lockout system having a lockout member configured to engage with at least one component of the actuating system, to restrict the flow of gas through the actuating system, is shown in FIGS. 21 and 22. In this form, the lockout member 86 is connected to a compressed gas powered trap comprising an actuation system comprising a gas reservoir 82, for storing gas therein, and a bleed trigger compressed gas circuit comprising a first portion 80 and a second portion 87. The first and second portions 80, 87 of the circuit may or may not be in fluid communication depending on the position of the lockout member 86 within the lockout system. In one form, the gas reservoir 82 holds compressed gas at an operating pressure, which gas is received from a high pressure gas storage vessel via a pressure regulator.

A first wall portion 79 and a second wall portion 81 define the bleed trigger compressed gas circuit, which runs between the first and second wall portions. A cavity 89 may be formed in the first wall portion 79 for receiving at least a portion of the lockout member 86 therein. A third wall portion 83, together with the second wall portion 81 may define the gas reservoir 82, so that the gas reservoir 82 is located between the second and third wall portions 81, 83. A path 84 may extend through the second wall partition 81. The wall portions 79, 81, 83 are impermeable.

The lockout member 86 is configured to move within a limited range and is fitted with a seal 85, such as a rolling diaphragm seal, configured to seal the path 84 that lies between the gas reservoir 82 and the bleed trigger compressed gas circuit. Therefore, the seal 85 prevents the flow of gas between the gas reservoir 82 and the bleed trigger compressed gas circuit.

The lockout system may also comprise a biasing member configured to bias the lockout member to the closed position.

In one form, a biasing member, such as a spring 88 may be located between one end of the lockout member and a closed end of the cavity 89 to press against the lockout member 86. In this configuration, the pressure from the spring against the lockout member 86 may bias the lockout member 86 toward the gas reservoir 82. For example, when the gas pressure in the gas reservoir 82 is below a set threshold, the biasing member 88 pushes the lockout member 86 away from the cavity 89 and toward the gas reservoir 82. Under the force of the biasing member 88, an end portion of the lockout member 86 is pushed into the path 84 and may engage with the second wall portion 81 that lies between the bleed trigger compressed gas circuit and the gas reservoir 82 by seating against the second wall portion 81. In this extended position, the lockout member 86 causes a barrier between the first and second portions 80, 87 of the bleed trigger compressed gas circuit so that gas flow between the first and second portions 80, 87 of the bleed trigger is restricted or prevented.

The lockout member 86 may therefore be used to block a bleed of compressed gas from a normally closed pneumatically piloted control valve through a bleed trigger valve, via a bleed trigger compressed gas circuit, if the gas pressure in the gas reservoir 82 is below the set threshold.

However, if the gas pressure in the gas reservoir 82 becomes greater than the compression force of the biasing member or spring 88, the gas pressure will bias the lockout member 86 toward the cavity 89. For example, when the gas pressure in the gas reservoir 82 is above a set threshold, the pressurised gas pushes the lockout system 86 into cavity 89 to open the passage between the two portions 80, 87 of the bleed trigger compressed circuit. In this retracted position, gas may flow from the first portion 80 of the bleed trigger compressed gas circuit 80 to the second portion 87. The set threshold may be determined by the characteristics of the biasing member or spring 88, having regard to the other parameters of the device.

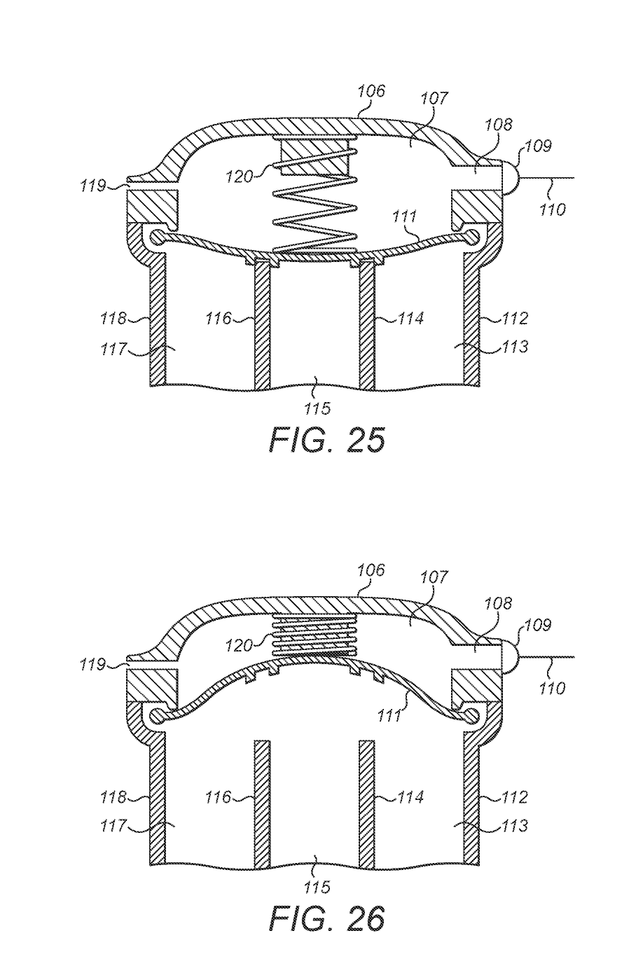

In another form, the lockout system may be configured to mechanically inhibit movement of a trigger mechanism or to prevent opening of a normally closed pneumatically piloted control valve. For example, FIGS. 25 and 26 show a lockout system configured to prevent opening of a diaphragm in a control valve where the gas supply pressure is below a threshold pressure.

In particular, FIG. 25 shows a cut away side view of a normally closed pneumatically piloted control valve of the diaphragm valve type fitted with a lockout system. This valve comprises an upper, pilot chamber 107 with a bonnet 106. The bonnet 106 is shown with a protrusion to retain one end of a biasing member, such as a spring 120. Alternatively, one end of the spring 120 may be retained by other means, such as by being recessed into bonnet 106. Alternatively or additionally, the other end of the spring 120 may be retained at the point where the spring is located against a diaphragm 111. The normally closed pneumatically piloted control valve with a lockout system comprises a gas supply and an inlet port 119 configured to allow pressurised gas from the gas supply to enter the upper chamber 107 at a controlled rate. The pressurised gas in the upper chamber 107 presses against and therefore biases the diaphragm 111 downwards to a closed position. In the closed position, the diaphragm 111 seals against walls 114 and 116 of the valve body. An outer rim of the diaphragm 111 is seated against outer walls 112 and 118 of the valve body and is held in place by the bonnet 106. Pressurised gas from the pressurised gas supply may enter a lower chamber of the valve through first and second chambers 113 and 117. The gas in the lower chamber may exert upward pressure against the diaphragm 111, but because this pressure is applied to a smaller area of the diaphragm 111 than the downward pressure from the pilot chamber 107, the valve is held closed.

Upon activation of a trigger 110, such as upon disturbance of a whisker 110, a bleed valve 109 allows pressurised gas to vent to the atmosphere from the pilot chamber 107 via an exhaust port 108. The exhaust port 108 is larger than the inlet port 119, so that as the bleed valve 109 is opened, the gas pressure in the pilot chamber 107 falls. Once the gas pressure has fallen enough, the diaphragm 111 is pushed upwards to the open or set position, as shown in FIG. 26, thereby opening the valve to allow pressurised gas to flow from the first and second chambers 113 and 117 to an outlet 115. The outlet 115 is connected to the actuation system of the strike member of the trap. A flow of sufficiently pressurised gas is needed to provide the strike member with sufficient force to humanely kill a creature interacting with the device.

Upward movement of the diaphragm 111 requires that the upwardly directed gas pressure in the chambers 113 and 117 is sufficient to overcome both the downwardly directed gas pressure in the pilot chamber 107 that presses against a greater upper surface area of the diaphragm, and the downward bias exerted against the diaphragm 111 by the biasing member or spring 120. If the gas pressure in the lower chambers 113 and 117 is too low then the diaphragm 111 will be unable to move upwards to the open or set position, which will prevent the actuation system from causing the strike member to strike, even when the bleed trigger valve 109 has been set off by interference with the whisker 110 or other trigger. Optionally, the force exerted by the spring 120 or other biasing member may be adjustable, such as by way of a set screw or the like.

The spring 120, or any other biasing member, may be calibrated through engineering calculations and field testing. By using a calibrated spring in the control valve of a lockout system for a pressurised gas powered kill trap, the trap should only operate to humanely kill a creature and should not operate under low gas pressure conditions, which may arise when the gas supply for the trap is nearing depletion.

In another form, one or more leaf springs are used instead of compression spring 120 to provide a similar downward bias against the top of diaphragm 111. In other forms, one or more springs are mounted below diaphragm 111 to provide a similar downward bias to it. In other forms, one or more springs are encased within the diaphragm. Alternatively, at least part of the diaphragm may be manufactured of a material and design that imparts a similar response to the diaphragm above and below a gas pressure threshold instead of using one or more springs, as described above.

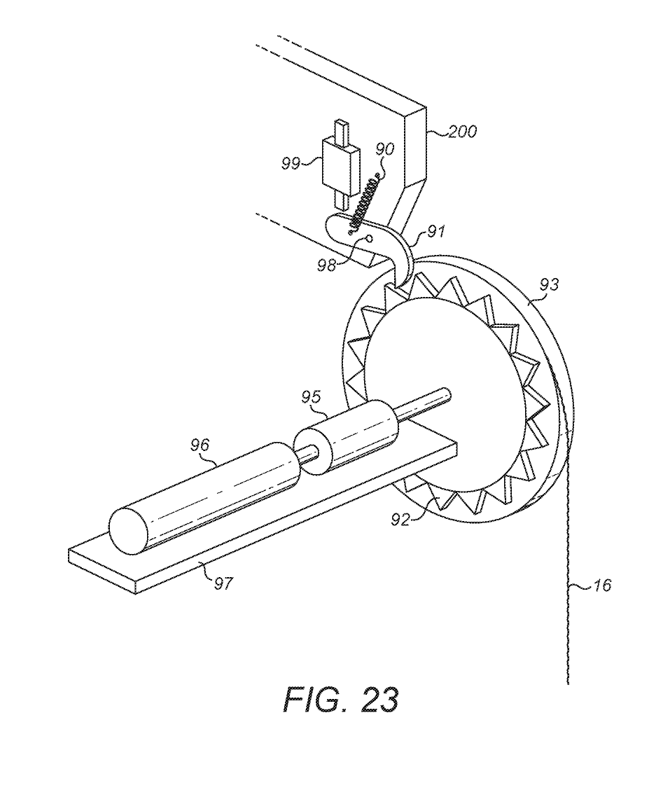

In another form, as shown in FIG. 23, the lockout system comprises a ratchet mechanism that is connected to a retractor, such as a pulley, of the trap resetting system. In this form, the trap may comprise a gear box 95 coupled to the pulley 93 and an electric motor 96 coupled to the gear box 95. The gear box 95 and the electric motor 96 may be mounted on a frame 97. The frame 97 may be connected to or be part of the trap housing 1. The pulley 93 is mounted on a rotatable axle, which may be mounted on bearings or the like and is attached to or integral with a cog 92. One end of a connecting line 16 is secured to the pulley 93 and the other end of the connecting line 16 is directly or indirectly connected to the trap's strike member.

The trap may also comprise a frame 200 that supports a pivot pin 98 upon which a lever, such as a pawl 91, swivels. In one form, a spring 90 connects the frame 200 and the pawl 91 and biases an engagement arm of the pawl toward the cog 92. In one form, the pawl comprises a lockout member that engages with the cog to prevent actuation of the strike member. In some forms, the spring 90 may not be necessary if the size, shape, weight distribution and/or mounting arrangement of the pawl 91 can bias the pawl towards the cog 92. A solenoid 99 is attached to the frame 200 and comprises an actuator arm configured to extend and retract depending on electronic signals received from a control system. In an extended position, the actuator arm of the solenoid 99 pushes against an end of the pawl 91 to cause the pawl 91 to pivot away from the cog 92 and to therefore disengage with the cog 92. When the actuator arm is in the retracted position, the pawl 91 may be caused to engage with the cog 92. The size, shape, weight distribution and mounting arrangement of the pawl 91 may allow the cog 92 and hence the pulley 93 to freely rotate in a first direction, such as a counter-clockwise direction, but prevent the cog 92 and hence the pulley 93 from rotating in a second, reverse direction, such as a clockwise direction when the pawl 91 is engaged with the cog 92.

The lock out system of FIG. 23 may also be configured to allow the lockout member to engage with the cog 92 during the strike member resetting phase. When the strike member is being reset to a set position, the connecting line 16 is wound onto the pulley 93 using a motor driven by a power source. If the power source for the trap is exhausted before the strike member is reset to the set position, the strike member will, in the absence of a lockout device, be inclined to return to the strike position due to the biasing force pressing against the strike member from springs 5 or 39, possibly causing injury to any creature in the trap. The lockout member prevents this from happening by preventing the cog 92 and pulley 93 from rotating.

In one form, the trap comprises a shock absorbing transmission system, as described above. In this form, once the strike member is fully reset, the actuator arm of the solenoid 99 can be used to disengage the pawl 91 from the cog 92, with the strike member held in the set position by a latch or similar. Once the pulley resetting system has reached the set position, the pulley 93 may be rotated in reverse to cause the connecting line 16 to be at least partially unwound to hang or lie slack.

In an alternative form, the pawl 91 may be left engaged with the cog 92 once the strike member is at the set position and may be used as a latch for the strike member. The latch may be releasable by retracting the actuator arm of the solenoid 99 under a signal from the trap's controller. Under this arrangement, a clutch or other shock absorbing transmission system may be used, such as between the pulley 93 and the gear box 95, to protect the electric motor 96 and the gear box 95 from any shock load upon the strike member being activated.

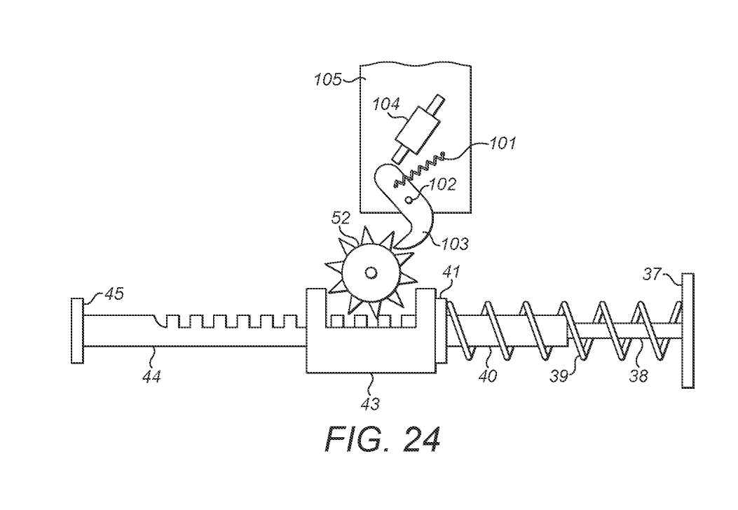

In one form, as shown in FIG. 24, the lockout system comprises a ratchet mechanism fitted to a trap's rack and pinion resetting system (of the type shown in FIGS. 13 and 14). In this form, the strike member 14 is shown in a strike position. The operation of the trap's rack and pinion resetting apparatus is as described for FIGS. 13 and 14.

In this form, a frame 105 supports a pivot pin 102 upon which a pawl 103 is configured to pivot. A biasing member, such as a spring 101, may connect the frame 105 and the locking member/pawl 103 to bias the pawl 103 toward the cog 52. In alternative forms, the size, shape, weight distribution and/or mounting arrangement of the pawl 103 may bias the pawl toward the cog 52. A solenoid 104 comprising an extendable and retractable actuator arm may be attached to the frame 105. When the actuator arm is in a retracted position, the pawl 103 may engage with the cog 52. When the actuator arm is in an extended position, the arm presses against one end of the pawl 103 to cause the pawl to pivot and disengage from the cog 52. The size, shape, weight and mounting arrangement of the pawl 103 allow the cog 52 to freely rotate in a first direction, such as a counter-clockwise direction, but prevent the cog 52 from rotating in a second, reverse direction, such as a clockwise direction, when the pawl 103 is engaged with the cog 52.

When the strike member 45 is being reset to a set position, the piston 45 is retracted by the cog 52. If the power source for the trap is exhausted before the strike member 14 is fully reset to its set position, the strike member 14 will be biased to a strike position under the force of the compression spring 39. The lock out system of FIG. 29 may be configured so that the pawl 103 may engage with the cog 52 during the strike member 14 resetting phase, as the piston is retracted by the cog 52. In this embodiment, if the power source for the trap is exhausted before the strike member 14 is fully reset to its set position, the cog 52 is prevented from rotating in one direction, such as the clockwise direction, the piston is prevented from extending and hence the strike member 45 is unable to strike.

Once the strike member is fully reset, the actuator arm of the solenoid 104 may be moved to disengage the pawl 103 from the cog 52, with the strike member 45 held in the set position by a latch or the like. In an alternative form, the pawl 103 may be left engaged with the cog 52 once the strike member 45 is fully reset and may be used as a latch for the strike member. The pawl/latch may be releasable from the strike member by retracting the actuator arm of the solenoid 104 under a signal from the control system 4. A clutch or other shock absorbing transmission system may be used to protect the electric motor and the gear box from any shock load upon activation of the strike member.

In a further form, a lockout system of a kill trap utilises a self-locking worm gear to drive the reset of the apparatus's strike member. If the apparatus's energy supply is exhausted before a reset is fully completed, the self-locking worm gear is configured to lock the apparatus in a partially reset position. Once energy supply is sufficient, such as through recharging of batteries for the trap, the reset may resume.

In another form, a control system of the trap may be configured as a lockout system to prevent an actuation or a release of the strike member if the strike member has not been fully reset to the set position due to the energy supply of the trap being exhausted before a reset is fully completed. A limit switch may be used to communicate to the control system whether or not the strike member has been fully reset to the set position.

In another form, the trap is a compressed gas powered trap and includes a control system comprising a processor and a computer-readable memory and is configured to estimate a remaining amount of compressed gas stored in the trap's gas storage vessel based on values stored in the computer-readable memory for an initial amount of compressed gas stored in the apparatus and an amount of compressed gas used by the trap up until a time of the estimate. The trap's control system is configured to prevent actuation or reset of the kill mechanism if the estimated remaining amount of compressed gas stored in the apparatus is less than a predetermined threshold amount.

In another form, the trap is a battery powered trap and includes a control system comprises a processor and a computer-readable memory and is configured to estimate a remaining amount of electrical energy stored in the trap's batteries based on values stored in the computer-readable memory for an initial amount of electrical energy stored in the apparatus and a net amount of electrical energy used by the trap up until a time of the estimate The trap's control system is configured to prevent actuation or reset of the kill mechanism if the estimated remaining amount of electrical energy stored in the batteries is less than a predetermined threshold amount.

In a further form the trap is a compressed gas powered trap and includes a digital gas pressure gauge configured to measure a pressure of gas stored in a gas storage location in the apparatus and which is connected to the trap's control system, comprising a processor and a computer-readable memory. The controller is configured to prevent actuation or reset of the kill mechanism if the pressure of the compressed gas stored in the gas storage location in the apparatus is less than a predetermined threshold amount.

In a further form, the trap is a battery powered trap and includes a digital battery gauge configured to measure an amount of electrical energy stored in one or more batteries in the apparatus and which is connected to the trap's control system, comprising a processor and a computer-readable memory. The controller is configured to prevent actuation or reset of the kill mechanism if the amount of electrical energy stored in the one or more batteries in the apparatus is less than a predetermined threshold amount.

In a further form the trap is a compressed gas powered trap and includes a pressure switch configured to measure a pressure of gas stored in a gas storage location in the apparatus, and either:—the pressure switch is configured to be normally closed if the pressure of gas stored in the gas storage vessel is above a predetermined threshold level and electrical current is required to flow through the pressure switch in order to actuate or reset the trap's kill mechanism, or the pressure switch is configured to be normally open if the pressure of gas stored in the gas storage vessel is above a predetermined threshold level and electrical current is required to be prevented from flowing through the pressure switch in order to actuate or reset the trap's kill mechanism.

In other forms, a trap comprises electronic circuitry that utilises one or more temporary electrical energy storage components, such as capacitors, to temporarily accumulate a charge of electrical energy immediately prior to resetting the kill mechanism or effecting a humane kill of the target creature and where resetting or actuation of the kill mechanism requires a directed discharge of electrical energy from the one or more capacitors. Furthermore, if the one or more capacitors have insufficient charge then no electrical energy will be discharged from the one or more capacitors and directed to reset or actuate the kill mechanism.

One or more of the components and functions illustrated in the figures may be rearranged and/or combined into a single component or embodied in several components without departing from the invention. Additional elements or components may also be added without departing from the invention.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. A trap comprising:
at least one trigger;
a strike member;
a power supply;
an actuating system connected to the strike member and configured to cause the strike member to move from a set position to a strike position when the actuating system is activated, wherein the actuating system is powered by the power supply;
and a lockout system configured to prevent the actuation system from activating the strike member when an energy level of the power supply is below a predetermined threshold.

2. The trap of claim 1, wherein the power supply is a compressed gas power supply, and the lockout system comprises a lockout member configured to be moveable between:
(a) an open position, in which a compressed gas can flow through the actuating system to enable the actuating system to activate the strike member, and
(b) a closed position, in which the lockout member restricts the flow of the compressed gas through the actuating system to prevent the actuation system from activating the strike member when a pressure of the compressed gas at a location in the trap is below a particular threshold.

3. The trap of claim 1, wherein the power supply is a compressed gas power supply, and wherein:
the actuating system comprises a pilot controlled diaphragm valve, and
the lockout system comprises a biasing member configured to bias a diaphragm of the pilot controlled diaphragm valve to a closed position when a pressure of a compressed gas at a location in the pilot controlled diaphragm valve is below a particular threshold.

4. The trap of claim 1, wherein the power supply is a compressed gas power supply, and wherein;
the actuating system is controlled by an electronic controller,
the lockout system comprises a pressure switch configured to measure a pressure of gas in a gas storage location in the trap, and
the electronic controller is configured to prevent the actuation system from activating the strike member when a signal status of the pressure switch signals that the pressure of gas at the gas storage location in the trap is below a predetermined threshold.

5. A trap comprising:
at least one trigger;
a strike member;
a power supply;
an actuating system connected to the strike member and configured to cause the strike member to move from a set position to a strike position when the actuating system is activated;
a resetting system connected to the strike member and configured to cause the strike member to move from a strike position to a set position when the resetting system is activated, wherein the resetting system is powered by the power supply; and
a lockout system configured to prevent the actuating system from being activated when the strike member has not been moved to the set position due to an insufficient energy level in the power supply.

6. A trap comprising:
at least one trigger;
a strike member;
a power supply;
an actuating system configured to connect to the strike member and configured to cause the strike member to move from a set position to a strike position when the actuating system is activated by the trigger;
a resetting system connected to the strike member via a connecting line, wherein the connecting line is also connected to a retractor, wherein the retractor is driven in a first direction by a motor, which causes the retractor to pull on the connecting line to cause the strike member to move from the strike position to the set position;
and a shock absorbing transmission system, configured to introduce slack to the connecting line to prevent transmission of an impact force, resulting from activation of the strike member, to the motor.

7. The trap of claim 6, wherein the trap comprises an electronic control system for receiving one or more actuating signals from the at least one trigger and activating the actuating system after receiving one or more of those signals.

8. The trap of claim 7, wherein the one or more actuating signals are electric signals received from an electrically powered trigger.

9. The trap of claim 8, wherein the electrically powered trigger comprises a sensor.

10. The trap of claim 7, wherein the one or more actuating signals comprise a physical force or movement of a mechanically operated trigger.

11. The trap of claim 6, wherein a gearing system is attached to the motor.

12. The trap of claim 11, wherein the gearing system comprises a gear box.

13. The trap of claim 6, wherein the retractor comprises a rotating member.

14. The trap of claim 13, wherein the rotating member is a pulley.

15. The trap of claim 6 wherein the trap comprises an electronic control system for operating the motor to cause the retractor to be driven in a second direction, which is the reverse of the first direction, to at least partially release the connecting line to introduce slack to the connecting line.

16. The trap of claim 6, wherein the connecting line is a flexible and at least partially stretchable line.
